(19) United States
(12) Patent Application Publication
(10) Pub. No.: US 2022/0240581 A1
(43) Pub. Date: Aug. 4, 2022

(54) HEATER AND LOW-TEMPERATURE HEATING SMOKING SET

(71) Applicant: SHENZHEN FIRST UNION TECHNOLOGY CO., LTD., Shenzhen, Guangdong Province (CN)

(72) Inventors: Wei CHEN, Shenzhen, Guangdong Province (CN); Ruilong HU, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 17/597,538

(22) PCT Filed: Jul. 14, 2020
(86) PCT No.: PCT/CN2020/101942

§ 371 Date: Jan. 11, 2022

(30) Foreign Application Priority Data
Jul. 15, 2019 (CN) 201910633746.9

(51) Int. Cl. A24F 40/46; F28F 13/18; A24F 40/20

(52) U.S. Cl. CPC A24F 40/46; A24F 40/20; F28F 13/18

(57) ABSTRACT

A heater and a low-temperature heating smoking set, wherein the heater comprises a base member, a conductive module, and a far infrared coating; the conductive module at least comprises a first conductive portion and a second conductive portion disposed on the base member; an outer side surface of the base member between the first conductive portion and the second conductive portion is coated by the far infrared coating (3); the first conductive portion and the second conductive portion are respectively provided with a first body portion and a second body portion, and a first extension segment and a second extension segment extending along an axial direction of the base member.

### TECHNICAL FIELD

The present disclosure relates to the technical field of smoking sets, and in particular to a heater and a lower-temperature heating smoking set.

### BACKGROUND

Traditional cigarettes, when burning, will generate harmful substances such as tar, carbon monoxide, etc., which are easy to be inhaled into consumers' bodies when they are smoking and thus endanger the health of the consumers. Therefore, a low-temperature heating non-burning smoking set appears, which can heat a cigarette to generate a smoke, and thus can reduce the generation of harmful substances and better protect the health of consumers. Most of present low-temperature heating non-burning smoking sets employ a central ceramic rod, a ceramic heating pin or an annular wall type steel pipe and the like to heat, however, these heating modes are prone to cause nonuniform heating in the process of heating cigarettes, resulting in low utilization of cigarettes, high use cost of smoking sets and poor user experience.

### SUMMARY

The present disclosure mainly aims to provide a heater capable of uniformly heating and a low-temperature heating smoking set using the heater.

In order to achieve the above aim, the present disclosure employs the following technical scheme. A heater is provided, including:

a base body, which includes a first end and a second end opposite to one another, wherein the base body extends along an axial direction between the first end and the second end and is hollow inside to form a heating chamber configured for containing a tobacco substrate;

a conductive module, which at least includes a first conductive portion and a second conductive portion that are arranged on the base body;

a far infrared coating, which is attached onto the base body between the first conductive portion and the second conductive portion, wherein the first conductive portion and the second conductive portion are both in electrical connection with the far infrared coating; wherein

the first conductive portion includes a first main part and a first extending section extending from the first main part along the axial direction of the base body, the second conductive portion includes a second main part and a second extending section extending from the second main part along the axial direction of the base body, the far infrared coating extends from the first main part to the second main part, wherein N is the proportion of a width along the circumferential direction of the base body of the far infrared coating located between the first extending section and the second extending section to a width along the axial direction of the far infrared coating located between the first extending section and the second main part, and/or the proportion of a width along the circumferential direction of the base body of the far infrared coating located between the first extending section and the second extending section to a width along the axial direction of the far infrared coating located between the second extending section and the first main part, and 0.8≤N≤1.2.

preferably, the width along the circumferential direction of the base body of the far infrared coating located between the first extending section and the second extending section is equal to the width along the axial direction of the far infrared coating located between the first extending section and the second main part, and/or the width along the circumferential direction of the base body of the far infrared coating located between the first extending section and the second extending section is equal to the width along the axial direction of the far infrared coating located between the second extending section and the first main part.

Preferably, the base body has a circular section, the far infrared coating is attached on a lateral surface of the base body, the first extending section and the second extending section extend in parallel and are symmetrically arranged on the lateral surface of the base body along a central axis of the base body.

Preferably, the far infrared coating extending from the first main part to the second main part is uniform in thickness.

Preferably, the first conductive portion further includes a third extending section extending from the first main part along the axial direction of the base body; the second conductive portion further includes a fourth extending section extending from the second main part along the axial direction of the base body; the first extending section, the second extending section, the third extending section and the fourth extending section are arranged on the base body at equal intervals along the circumference direction of the base body; a length of the third extending section along the axial direction of the base body is equal to a length of the first extending section along the axial direction of the base body, and a length of the fourth extending section along the axial direction of the base body is equal to a length of the second extending section along the axial direction of the base body.

Preferably, N1 is the proportion of a width along the circumferential direction of the base body of the far infrared coating located between the third extending section and the fourth extending section to a width along the axial direction of the far infrared coating located between the third extending section and the second main part, and/or the proportion of a width along the circumferential direction of the base body of the far infrared coating located between the third extending section and the fourth extending section to a width along the axial direction of the far infrared coating located between the fourth extending section and the first main part, and 0.8≤N1≤1.2.

Preferably, the width along the circumferential direction of the base body of the far infrared coating located between the third extending section and the fourth extending section is equal to the width along the axial direction of the far infrared coating located between the third extending section and the second main part, and/or the width along the circumferential direction of the base body of the far infrared coating located between the third extending section and the fourth extending section is equal to the width along the axial direction of the far infrared coating located between the fourth extending section and the first main part.

Preferably, the conductive module further includes a third conductive portion, the third conductive portion is arranged on the base body between the first conductive portion and the second conductive portion, the third conductive portion is in electrical connection with the far infrared coating, and the third conductive portion separates the far infrared coating into two heating areas along the axial direction of the base body, so as to heat the tobacco substrate inside the heating chamber in sections.

Preferably, the third conductive portion includes a third main part, a fifth extending section and a sixth extending section that extend along the axial direction of the base body, wherein the fifth extending section extends from the third main part towards the first main part, the sixth extending section extends from the third main part towards the second main part, the fifth extending section and the sixth extending section are arranged on the side surface of the base body at intervals centro-symmetrically to the first extending section and the second extending section respectively.

Preferably, N2 is the proportion of a width along the circumferential direction of the base body of the far infrared coating located between the fifth extending section and the first extending section to a width along the axial direction of the far infrared coating located between the first extending section and the third main part, and/or the proportion of a width along the circumferential direction of the base body of the far infrared coating located between the fifth extending section and the first extending section to a width along the axial direction of the far infrared coating located between the fifth extending section and the first main part, and 0.8≤N2≤1.2.

Preferably, N3 is the proportion of a width along the circumferential direction of the base body of the far infrared coating located between the sixth extending section and the second extending section to a width along the axial direction of the far infrared coating located between the sixth extending section and the second main part, and/or the proportion of a width along the circumferential direction of the base body of the far infrared coating located between the sixth extending section and the second extending section to a width along the axial direction of the far infrared coating located between the second extending section and the third main part, and 0.8≤N≤1.2.

Preferably, the first conductive portion and the second conductive portion are both a conductive coating applied on the outer surface of the base body.

Preferably, the first conductive portion and the second conductive portion are both a conductive ring sleeved on the outer surface of the base body.

Preferably, the base body is made of quartz glass or mica.

The present disclosure also provides a low-temperature heating smoking set, including a shell assembly and the above heater, wherein the heater is arranged inside the shell assembly.

According to the heater and the low-temperature heating smoking set provided in the present disclosure, the base body is provided with a far infrared coating, a first conductive portion and a second conductive portion that are in electrical connection with the far infrared coating, and a first extending section and a second extending section that extend along the axial direction of the base body from the first conductive portion and the second conductive portion respectively; control the proportion of a width along the circumferential direction of the base body of the far infrared coating located between the first extending section and the second extending section to a width along the axial direction of the far infrared coating located between the first extending section and the second conductive portion, and/or the proportion of a width along the circumferential direction of the base body of the far infrared coating located between the first extending section and the second extending section to a width along the axial direction of the far infrared coating located between the second extending section and the first conductive portion, so that the proportion is within a preset range; when the first conductive portion and the second conductive portion are connected to positive and negative electrodes of an external power source, the current will flow to the first extending section from the first conductive portion, and then part of the current flows to the second extending section via the far infrared coating along the circumferential direction of the base body, and the other part of the current flows to the second main part from the far infrared coating located between the first extending section and the second main part; when the proportion is within a preset range, all the far infrared coating on the base body can have a current flowing through and the current flowing through the far infrared coating on the base body is basically of the same magnitude, thus the far infrared coating can emit infrared lights to radiate and heat the cigarette inside the heating chamber. The cigarette is uniformly heated, having a high utilization, and the low-temperature heating smoking set has a better user experience.

### BRIEF DESCRIPTION OF THE DRAWINGS

For a better understanding of the technical scheme in the embodiments of the present disclosure, accompanying drawings needed in the description of the embodiments are simply illustrated below. Obviously, the accompanying drawings described below are some embodiments of the present disclosure merely. For the ordinary skill in the field, other accompanying drawings may be obtained according to the structures shown in these accompanying drawings without creative work.

FIG. 1 is a structure diagram of an infrared heating tube according to one embodiment of the present disclosure.

FIG. 2 is a structure diagram of an infrared heating tube according to another embodiment of the present disclosure.

FIG. 3 is a diagram of a section of the infrared heating tube shown in FIG. 2.

FIG. 4 is a structure diagram of an infrared heating tube according to yet another embodiment of the present disclosure.

FIG. 5 is a structure diagram of a low-temperature heating smoking set according to one embodiment of the present disclosure.

FIG. 6 is a breakdown structure diagram of a low-temperature heating smoking set according to one embodiment of the present disclosure.

FIG. 7 is a sectional view of a low-temperature heating smoking set according to one embodiment of the present disclosure.

In the drawings: 10 represents a heater, 1 represents a base body, 11 represents a first end, 12 represents a second end, 13 represents a heating chamber 13, 2 represents a conductive module, 21 represents a first conductive portion, 211 represents a first main part 211, 212 represents a first extending section, 213 represents a third extending section, 22 represents a second conductive portion, 221 represents a second main part, 222 represents a second extending section, 223 represents a fourth extending section, 23 represents third conductive portion, 231 represents a third main part, 232 represents a fifth extending section, 233 represents a sixth extending section, 3 represents a far infrared coating, 4 represents a shell assembly, 41 represents an outer shell, 42 represents a fixing shell, 421 represents a front shell, 422 represents a rear shell, 43 represents a fixing element, 431 represents an upper fixing seat, 432 represents a lower fixing seat, 44 represents a bottom cover, 441 represents an air inlet pipe, 5 represents a heat insulation tube, 6 represent a control mainboard, 61 represents a charging interface, 7 represents a button, 8 represents a battery, 9 represents a temperature measurement element, and 100 represents a low-temperature heating smoking set.

### DETAILED DESCRIPTION

For a better understanding of the present disclosure, a detailed description is provided below to the present disclosure in conjunction with the drawings and specific embodiments. It is to be noted that when an element is described as “fixed on”/“fixedly connected to” another element, it may be directly on the another element, or there might be one or more intermediate elements between them. When one element is described as “connected to” another element, it may be directly connected to the another element, or there might be one or more intermediate elements between them. Terms “vertical”, “horizontal”, “left”, “right,” “inner”, “outer” and similar expressions used in this description are merely for illustration.

Unless otherwise defined, all technical and scientific terms used in the description have the same meaning as those normally understood by the skill in the technical field of the present disclosure. The terms used in the description of the present disclosure are just for describing specific implementations, not to limit the present disclosure. Terms “and/or” used in the description include any and all combinations of one or more listed items.

In addition, technical features involved in different embodiments of the present disclosure described below can be combined mutually if no conflict is incurred.

In the description, the installation includes fixing or limiting one element or device to a particular position or place by means of welding, screwing, clamping, bonding and the like, the element or device can remain stationary at a specific position or place or move within a limited range, and the element or device can be or not be detached after fixed or limited to the particular position or place, which are not limited in the present disclosure.

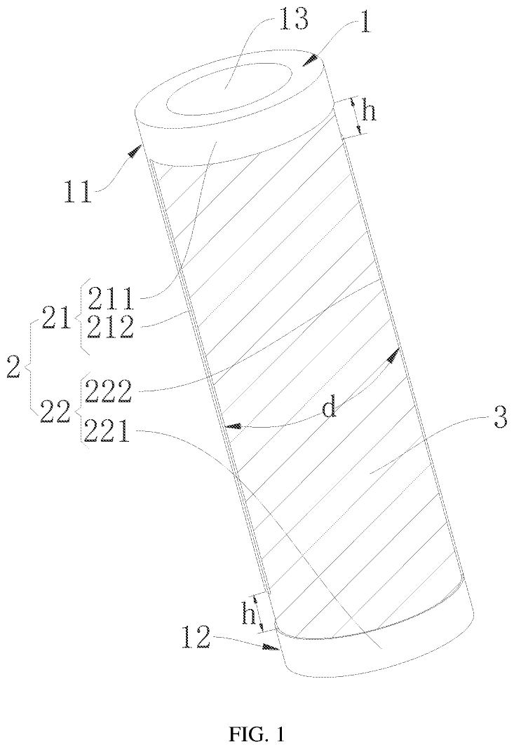

Referring to FIG. 1, a heater 10 according to one embodiment of the present disclosure includes a base body 1, a conductive module 2 and a far infrared coating 3.

Referring to FIG. 1, the base body 1 includes a first end 11 and a second end 12 opposite to one another, wherein the base body 1 extends along an axial direction between the first end 11 and the second end 12 and is hollow inside to form a heating chamber 13 configured for containing a tobacco substrate; the base body 1 may be made of a high temperature-resistance transparent material such as quartz glass, ceramic or mica; the base body 1 preferably is a hollow cylinder, the heating chamber 13 is a hole running through the middle part of the base body 1, and it is just needed to insert a tobacco substrate such as a cigarette into the heating chamber 13 when to heat the tobacco substrate.

Referring to FIG. 1, the conductive module 2 includes a first conductive portion 21 and a second conductive portion 22 that are arranged on the base body 1; preferably, the first conductive portion 21 is arranged on a lateral surface of the base body 1 near the first end 11, the second conductive portion 22 is arranged on a lateral surface of the base body 1 near the second end 12; of course, when the far infrared coating 3 is arranged on an inner side surface of the base body 1, the conductive module 2 can also be arranged on the inner side surface of the base body 1; in the preset embodiment, the first conductive portion 21 and the second conductive portion 22 are both circular, the first conductive portion 21 and the second conductive portion 22 can be a circular conductive coating applied on the lateral surface of the base body 1 near the first end 11 and the second end 12 respectively; the conductive coating is a metallic coating or a conductive tape and the like, also can be a circular conductive sheet sleeved on the lateral surface of the base body 1 near the first end 11 and the second end 12, the conductive sheet is a metallic conductive sheet, such as copper sheet, steel sheet and so on.

In the present embodiment, referring to FIG. 1, the far infrared coating 3 is applied onto the base body 1 between the first conductive portion 21 and the second conductive portion 22, first conductive portion 21 and the second conductive portion 22 are both in electrical connection with the far infrared coating 3. Preferably, the far infrared coating 3 may be applied on the lateral surface of the base body 1, also may be applied on the inner side surface of the base body 1. When the far infrared coating 3 is applied on the inner side surface of the base body 1, a protection layer may be arranged on the surface of the far infrared coating 3, for example a glass layer and the like. The present embodiment preferably applies the far infrared coating 3 on the lateral surface of the base body 1. In the present embodiment, the first conductive portion 21 and the second conductive portion 22 preferably are a conductive coating; the far infrared coating 3 preferably is a mixture of far-infrared electrothermal ink, ceramic powder and inorganic adhesive that is fully stirred and then is coated on the lateral surface of the base body 1 and dried and cured for certain time, the far infrared coating 3 has a thickness of 30 μm-50 μm; of course, the far infrared coating 3 can also be a mixture of tin tetrachloride, tin oxide, antimony trichloride, titanium tetrachloride and anhydrous copper sulfate in certain proportion that is stirred and then coated on the lateral surface of the base body 1; or, the far infrared coating 3 is one of silicon carbide ceramic layer, carbon fiber composite layer, zirconium titanium oxide ceramic layer, zirconium titanium nitride ceramic layer, zirconium titanium boride ceramic layer, zirconium titanium carbide ceramic layer, iron oxide ceramic layer, iron nitride ceramic layer, iron boride ceramic layer, iron carbide ceramic layer, rare earth oxide ceramic layer, rare earth nitride ceramic layer, rare earth boride ceramic layer, rare earth carbide ceramic layer, nickel cobalt oxide ceramic layer, nickel cobalt nitride ceramic layer, nickel cobalt boride ceramic layer, nickel cobalt carbide ceramic layer or high silicon molecular sieve ceramic layer; the far infrared coating 3 can also be other existing material coatings. The conductive coating is closely connected with the far infrared coating 3, thereby ensuring the current, when electrified, can flow to the second conductive portion 22 from the first conductive portion 21 via the far infrared coating 3, and avoiding the existence of gap that causes part of the far infrared coating 3 to be unelectrified and to be unable to emit far infrared lights and thus influences the heater 10 uniformly heating the tobacco substrate inside the heating chamber 13.

Referring to FIG. 1, in the present embodiment, the first conductive portion 21 includes a first main part 211 and a first extending section 212 extending from the first main part 211 along the axial direction of the base body, the second conductive portion 22 includes a second main part 221 and a second extending section 222 extending from the second main part along the axial direction of the base body 1, the first extending section 212 and the second extending section 222 are centro-symmetrically arranged on the lateral surface of the base body 1 at intervals; specifically, N is the proportion of a width along the circumferential direction of the lateral surface of the base body 1 of the far infrared coating 3 located between the first extending section 212 and the second extending section 222 to a width along the axial direction of the far infrared coating located between the first extending section 212 and the second main part 221, and/or the proportion of a width along the circumferential direction of the lateral surface of the base body 1 of the far infrared coating 3 located between the first extending section 212 and the second extending section 222 to a width along the axial direction of the far infrared coating 3 located between the second extending section 222 and the first main part 211, and 0.8≤N≤1.2. It is to be noted that, as shown in FIG. 1, the above width along the circumferential direction refers to a distance extending from the first extending section 212 to the second extending section 222 along the circumferential direction of the arced lateral surface of the base body 1, that is, the distance d shown in FIG. 1; the above width along the axial direction refers to a distance extending from the first extending section 212 to the second main part 221 along the axial direction of the base body 1, or a distance extending from the second extending section 222 to the first main part 211 along the axial direction of the base body 1, that is, the distance h shown in FIG. 1. In the present embodiment, N preferably selects 1, that is to say, the width along the circumferential direction of the lateral surface of the base body 1 of the far infrared coating 3 located between the first extending section 212 and the second extending section 222 is equal to the width along the axial direction of the far infrared coating 3 located between the first extending section 212 and the second main part 221, and/or the width along the circumferential direction of the lateral surface of the base body 1 of the far infrared coating 3 located between the first extending section 212 and the second extending section 222 is equal to the width along the axial direction of the far infrared coating 3 located between the second extending section 222 and the first main part 211. Further, it is worth mentioning that, in the present embodiment, the first extending section 212 and the second extending section 222 have an equal length, such that the distance between the first extending section 212 and the second main part 221 is equal to the distance between the second extending section 222 and the first main part 211.

The first extending section 212 and the extending section part 222 roughly divides the far infrared coating 3 on the lateral surface of the base body 1 into two symmetrical parts, the first extending section 212 and the extending section part 222 are centro-symmetrically arranged on the lateral surface of the base body 1, in this way, the width of the far infrared coating 3 between the first extending section 212 and the second extending section 222 along the clockwise circumferential direction of the lateral surface of the base body 1 is equal to the width of the far infrared coating 3 between the first extending section 212 and the second extending section 222 along the anticlockwise circumferential direction of the lateral surface of the base body 1. Thus, by controlling the distance from the first extending section 212 and the second extending section 222 to the first main part 211 and the second main part 221 respectively, the width along the axial direction of the far infrared coating 3 located between the first extending section 212 and the second main part 221 and the width along the axial direction of the far infrared coating 3 located between the second extending section 222 and the first main part 211 can be controlled, hereby the proportion of the circumferential width to the axial width can be controlled such that it falls within a fixed range. Specifically, when the first conductive portion 21 and the second conductive portion 22 are connected to positive and negative electrodes of an external power source, the far infrared coating 3 between the first conductive portion 21 and the second conductive portion 22 amounts to an equivalent resistor; since the first conductive portion 21 and the second conductive portion 22 have a first extending section 212 and a second extending section 222 respectively, the two parts of the far infrared coating 3 located between the first extending section 212 and the second extending section 222, the far infrared coating 3 located between the first extending section 212 and the second main part 221, and the far infrared coating 3 located between the second extending section 222 and the first main part 211 amount to four equivalent resistors in parallel connection; by controlling the proportion between the circumferential width and the axial width, the four equivalent resistors can have approximately same resistance values, then the currents flowing through the four equivalent resistors are of approximately the same magnitude, that is to say, the currents flowing through each part of the far infrared coating 3 are substantially of the same magnitude, each part of the far infrared coating 3 has a current flowing through and there is little difference in the magnitude of the current; therefore, the far infrared coating 3 in each part together emits far infrared lights of approximately the same intensity, which can uniformly radiate and heat the tobacco substrate inside the base body 1; the tobacco substrate such as cigarette is uniformly heated, has a high utilization and can effectively save cost.

Further, in the above embodiment, the first main part 211 and the second main part 221 may be a conductive coating, also may be a conductive sheet; when the first main part 211 and the second main part 221 are a conductive sheet, they are both a ring shaped conductive sheet having a fracture notch, so as to be sleeved on the lateral surface of the base body; the first extending section 212 and the second extending section 222 may be a conductive sheet, also may be a conductive coating. When the first conductive portion 21 and the second conductive portion 22 are both a conductive coating, a far infrared coating 3 is first applied on the lateral surface of the base body 1, then a conductive coating is applied on the far infrared coating 3, so that the conductive coating is in a tight connection with and keeps an electrical connection with the far infrared coating 3, thereby ensuring smooth electrification.

In one embodiment, the base body 1 has a circular section, the far infrared coating 3 is attached on a lateral surface of the base body 1, the first extending section 212 and the second extending section 222 extend in parallel and are symmetrically arranged on the lateral surface of the base body 1 along a central axis of the base body 1; in this way, the far infrared coating 3, between the first extending section 212 and the second extending section 22, is divided into two parts that are equal in the width along the circumferential direction of the base body 1; when the far infrared coating 3 is electrified, the two parts of the far infrared coating 3 have a same magnitude of current flowing through and can emit infrared lights of the same intensity, to uniformly radiate and heat the tobacco substrate inside the base body 1. It is worth mentioning that, in the present embodiment, the far infrared coating 3 extending from the first main part 211 to the second main part 221 is uniform in thickness, to ensure that the far infrared coating 3 emits far infrared lights of approximately the same intensity after electrified.

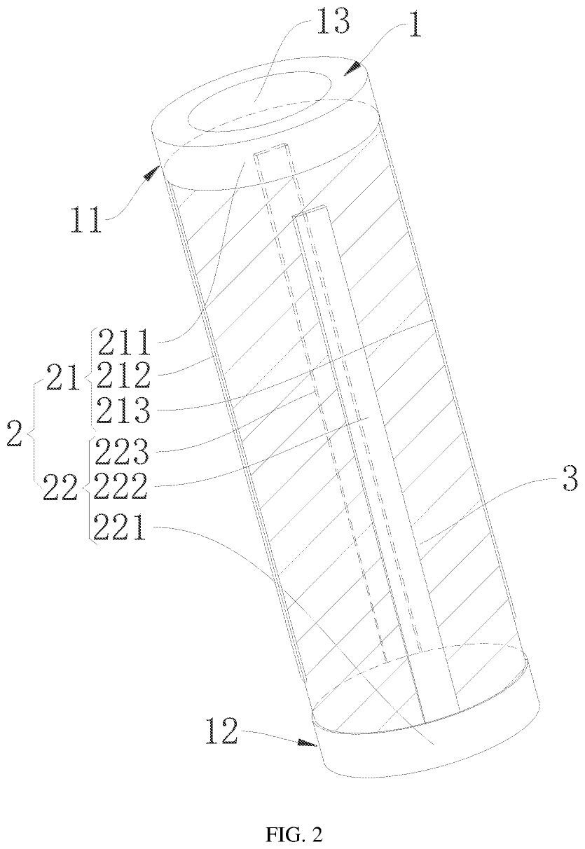

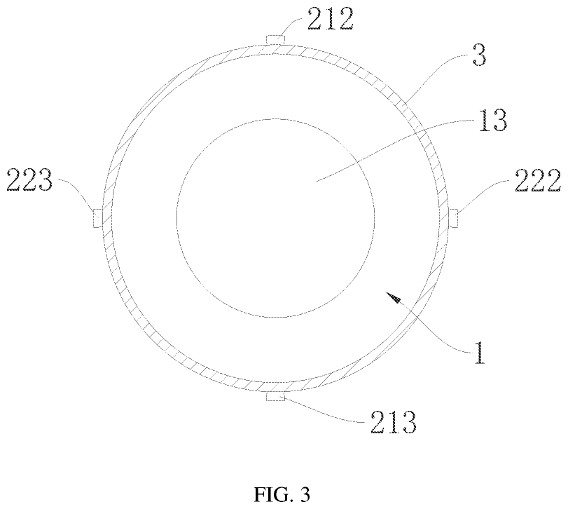

Referring to FIG. 2 to FIG. 3, in one embodiment, the first conductive portion 21 further includes a third extending section 213 extending from the first main part 211 along the axial direction of the base body 1; the second conductive portion 22 further includes a fourth extending section 223 extending from the second main part 221 along the axial direction of the base body 1; the first extending section 212, the second extending section 222, the third extending section 213 and the fourth extending section 223 are arranged on the lateral surface of the base body 1 at equal intervals along the clockwise circumference direction of the base body 1; a length of the third extending section 213 is equal to a length of the first extending section 212, and a length of the fourth extending section 223 is equal to a length of the second extending section 222. In the present embodiment, the first extending section 212 and the second extending section 222 have an equal length. The first extending section 212, the second extending section 222, the third extending section 213 and the fourth extending section 223 divide the far infrared coating 3 on the lateral surface of the base body 1 into four parts, and adjacent extending sections have an equal distance along the circumferential direction of the lateral surface of the base body 1; specifically, N1 is the proportion of a width along the circumferential direction of the base body of the far infrared coating 3 located between the third extending section 213 and the fourth extending section 223 to a width along the axial direction of the far infrared coating 3 located between the third extending section 213 and the second main part 221, and/or the proportion of a width along the circumferential direction of the base body of the far infrared coating 3 located between the third extending section 213 and the fourth extending section 223 to a width along the axial direction of the far infrared coating 3 located between the fourth extending section 223 and the first main part 211, wherein 0.8≤N1≤1.2, and N1 preferably is 1, that is to say, the width along the circumferential direction of the lateral surface of the base body 1 of the far infrared coating 3 located between the third extending section 213 and the fourth extending section 223 is equal to the width along the axial direction of the far infrared coating 3 located between the third extending section 213 and the second main part 221, and/or the width along the circumferential direction of the lateral surface of the base body 1 of the far infrared coating 3 located between the third extending section 213 and the fourth extending section 223 is equal to the width along the axial direction of the far infrared coating 3 located between the fourth extending section 223 and the first main part 211. When the first conductive portion 21 and the second conductive portion 22 are connected to positive and negative electrodes of an external power source, a current first flows to the first extending section 212 and the third extending section 213 from the first conductive portion 21, then part of the current flows from the first extending section 212 and the third extending section 213 to the second extending section 222 and the fourth extending section 223 via the far infrared coating 3 along the circumferential direction of the lateral surface of the base body 1, and then flows to the second conducive portion 22 through the second extending section 222 and the fourth extending section 223, while the other part of the current flows to the second conductive portion 22 via the far infrared coating 3 between the first extending section 212/the third extending section 213 and the second conductive portion 22, and finally to the negative electrode of the external power source to form a current circuit; all the far infrared coating 3 on the lateral surface of the base body 1 can have a current flowing through and the current is basically of the same magnitude, the infrared lights emitted by the far infrared coating 3 can uniformly radiate and heat the tobacco substrate inside the heating chamber 13 of the base body 1. The cigarette, which is uniformly heated, has a higher utilization, can reduce the frequency of replacement, and thus lowers the cost.

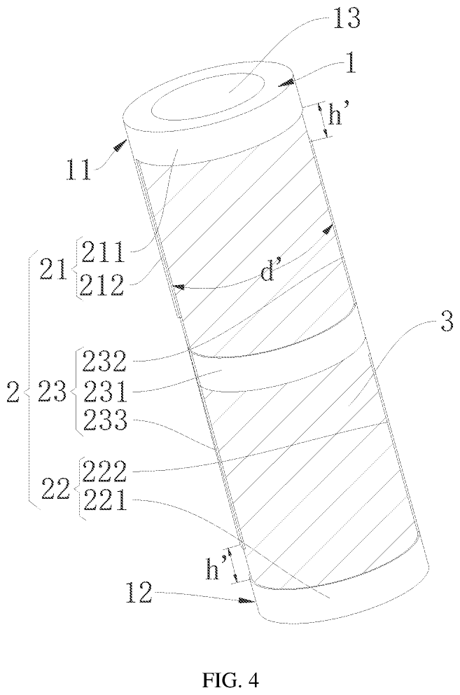

Referring to FIG. 4, in one embodiment, the conductive module 2 further includes a third conductive portion 23, the third conductive portion 23 is arranged on the lateral surface of the base body 1 between the first conductive portion 21 and the second conductive portion 22, the third conductive portion 23 is in electrical connection with the far infrared coating 3, and the third conductive portion 23 separates the far infrared coating 3 into two heating areas along the axial direction of the base body 1, so as to heat the tobacco substrate inside the heating chamber 13 in sections. In the present embodiment, the third conductive portion 23 divides the far infrared coating 3 into two heating areas, which can heat the tobacco substrate inside the heating chamber 13 in sections by controlling the electricity connection and disconnection of the first conductive portion 21, the second conductive portion 22 and the third conductive portion 23.

Further, the third conductive portion 23 includes a third main part 231, a fifth extending section 232 and a sixth extending section 233 that extend from the third main part 231 along the axial direction of the base body 1, wherein the fifth extending section 232 extends from the third conductive portion 23 towards the first conductive portion 21, the sixth extending section 233 extends from the third conductive portion 23 towards the second conductive portion 22, the fifth extending section 232 and the sixth extending section 233 are arranged on the lateral surface of the base body 1 at intervals centro-symmetrically to the first extending section 212 and the second extending section 222 respectively. Specifically, the third conductive portion 23 can have multiple extending sections, which are distributed similar to the above embodiment, and no further description is needed here.

Specifically, in one embodiment, N2 is the proportion of a width along the circumferential direction of the lateral surface of the base body 1 of the far infrared coating 3 located between the fifth extending section 232 and the first extending section 212 to a width along the axial direction of the far infrared coating 3 located between the first extending section 212 and the third main part 231, and/or the proportion of a width along the circumferential direction of the lateral surface of the base body 1 of the far infrared coating 3 located between the fifth extending section 232 and the first extending section 212 to a width along the axial direction of the far infrared coating 3 located between the fifth extending section 232 and the first main part 211, and 0.8≤N2≤1.2. It is to be noted that, as shown in FIG. 4, the above width along the circumferential direction refers to a distance extending from the first extending section 212 to the fifth extending section 232 along the circumferential direction of the arced lateral surface of the base body 1, that is, the distance d′ shown in FIG. 4; the above width along the axial direction refers to a distance extending from the first extending section 212 to the third main part 231 along the axial direction of the base body 1, or a distance extending from the fifth extending section 232 to the first main part 211 along the axial direction of the base body 1, that is, the distance h′ shown in FIG. 4. N2 preferably is equal to 1, that is to say, the width along the circumferential direction of the lateral surface of the base body 1 of the far infrared coating 3 located between the fifth extending section 232 and the first extending section 212 is equal to the width along the axial direction of the far infrared coating 3 located between the first extending section 212 and the third main part 231, and/or the width along the circumferential direction of the lateral surface of the base body 1 of the far infrared coating 3 located between the fifth extending section 232 and the first extending section 212 is equal to the width along the axial direction of the far infrared coating 3 located between the fifth extending section 232 and the first main part 211, such that the far infrared coating 3 emits infrared lights uniformly to heat the tobacco substrate.

Further, N3 is the proportion of a width along the circumferential direction of the lateral surface of the base body 1 of the far infrared coating 3 located between the sixth extending section 233 and the second extending section 222 to a width along the axial direction of the far infrared coating 3 located between the sixth extending section 233 and the second main part 221, and/or the proportion of a width along the circumferential direction of the lateral surface of the base body 1 of the far infrared coating 3 located between the sixth extending section 233 and the second extending section 222 to a width along the axial direction of the far infrared coating 3 located between the second extending section 222 and the third main part 231, and 0.8≤N≤1.2. It is to be noted that, as shown in FIG. 4, the above width along the circumferential direction refers to a distance extending from the second extending section 222 to the sixth extending section 233 along the circumferential direction of the arced lateral surface of the base body 1, that is, the distance d′ shown in FIG. 4; the above width along the axial direction refers to a distance extending from the second extending section 222 to the third main part 231 along the axial direction of the base body 1, or a distance extending from the sixth extending section 233 to the second main part 221 along the axial direction of the base body 1, that is, the distance h′ shown in FIG. 4. N3 preferably is equal to 1, that is to say, the width along the circumferential direction of the lateral surface of the base body 1 of the far infrared coating 3 located between the sixth extending section 233 and the second extending section 222 is equal to the width along the axial direction of the far infrared coating 3 located between the sixth extending section 233 and the second main part 221, and/or the width along the circumferential direction of the lateral surface of the base body 1 of the far infrared coating 3 located between the sixth extending section 233 and the second extending section 222 is equal to the width along the axial direction of the far infrared coating 3 located between the second extending section 222 and the third main part 231.

It is worth mentioning that, in some other embodiments, there might be multiple conductive portions, for example, four, five, etc.; the multiple conductive portions divide the far infrared coating 3 into three parts, four parts, etc., so as to heat the tobacco substrate in sections, such as in three sections, in four sections, etc.

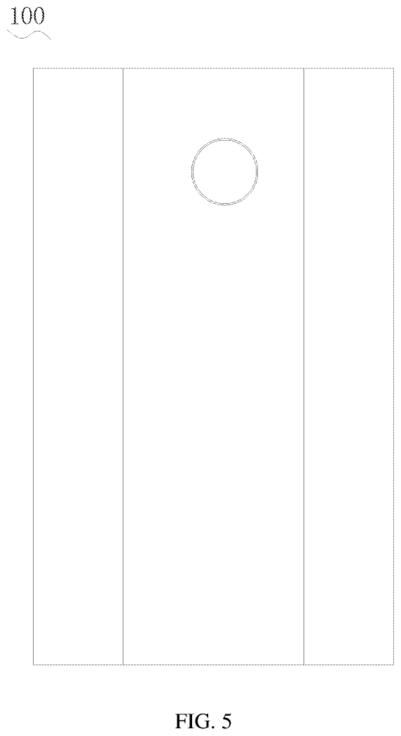

Referring to FIG. 5 to FIG. 7, the embodiment of the present disclosure further provides a low-temperature heating smoking set 100, including a shell assembly 4 and the above heater 10, wherein the heater is arranged inside the shell assembly 4. According to the low-temperature heating smoking set 100 provided in the embodiment of the present disclosure, a lateral surface of the base body 1 is provided with a far infrared coating 3, a first conductive portion 21 and a second conductive portion 22 that are in electrical connection with the far infrared coating 3, and a first extending section 212 and a second extending section 222 that extend along the axial direction of the base body 1 from the first conductive portion 21 and the second conductive portion 22 respectively; control the proportion of a width along the circumferential direction of the lateral surface of the base body 1 of the far infrared coating 3 located between the first extending section 212 and the second extending section 222 to a width along the axial direction of the far infrared coating 3 located between the first extending section 212 and the second conductive portion 22, and/or the proportion of a width along the circumferential direction of the lateral surface of the base body 1 of the far infrared coating 3 located between the first extending section 212 and the second extending section 222 to a width along the axial direction of the far infrared coating 3 located between the second extending section 222 and the first conductive portion 21, so that the proportion is within a preset range; when the first conductive portion 21 and the second conductive portion 22 are connected to positive and negative electrodes of an external power source, the current will flow to the first extending section 212 from the first conductive portion 21, and then part of the current flows to the second extending section 222 via the far infrared coating 3 along the circumferential direction of the base body 1, and the other part of the current flows to the second main part 221 from the far infrared coating located between the first extending section and the second main part 221; when the proportion is within a preset range, the current flowing through the far infrared coating on the lateral surface the base body 1 is basically of the same magnitude, and the far infrared coating 3 on the lateral surface of the base body 1 basically has a current flowing through, thus the far infrared coating 3 can emit infrared lights to radiate and heat the cigarette inside the heating chamber 13 of the base body 1. The cigarette is uniformly heated, having a high utilization, and the low-temperature heating smoking set 100 has a better user experience.

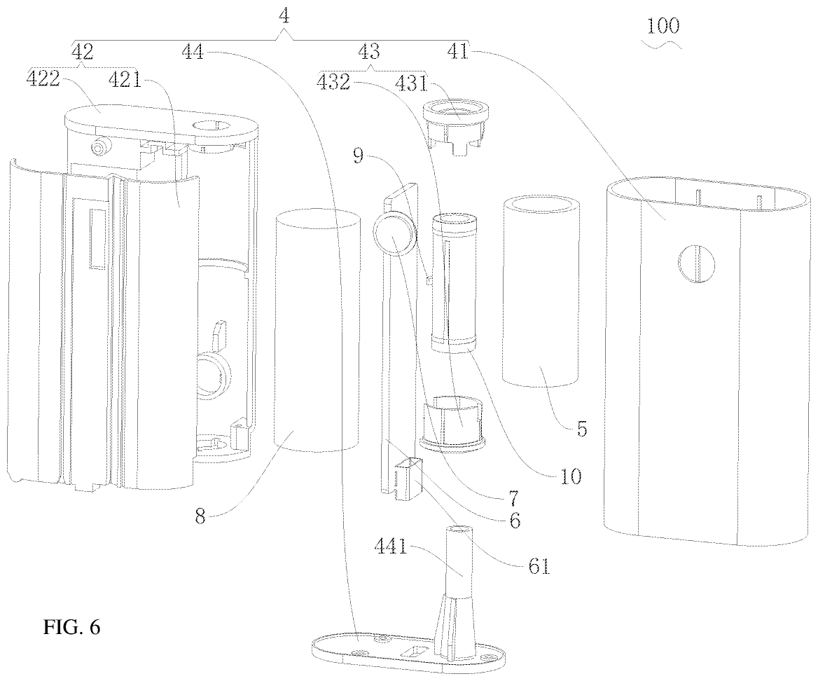

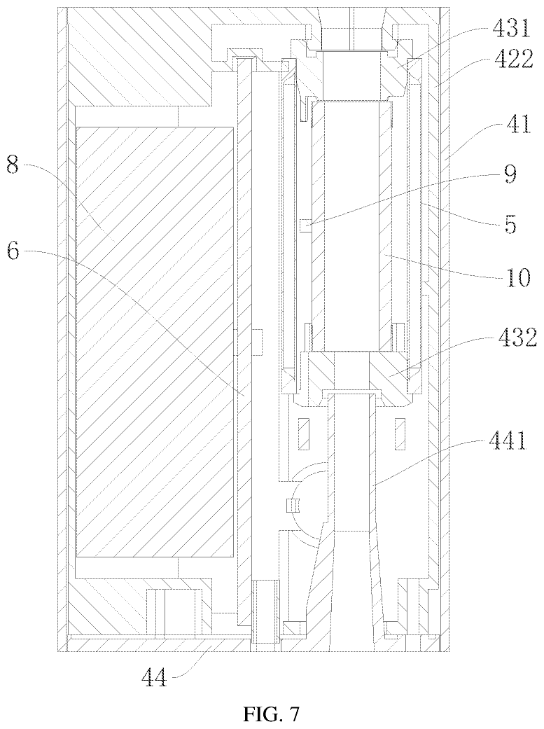

Referring to FIG. 6 to FIG. 7, the shell assembly 4 includes an outer shell 41, a fixing shell 42, a fixing element 43 and a bottom cover 44, wherein the fixing shell 42 and the fixing element 43 are both fixed inside the outer shell 41, the fixing element 43 is configured for fixing the heater 10, the fixing element 43 is arranged inside the fixing shell 42, the bottom cover 44 is arranged on one end of the outer shell 41 and covers the outer shell 41; specifically, the fixing element 43 includes an upper fixing seat 431 and a lower fixing seat 431, the upper fixing seat 431 and the lower fixing seat 431 are both arranged inside the fixing shell 43, a first end 11 and a second end 12 of the heater 10 are fixed on the upper fixing seat 431 and the lower fixing seat 432 respectively, an air inlet pipe 441 is arranged projecting from the bottom cover 44, one end of the lower fixing seat 432 away from the upper fixing seat 431 is connected to the air inlet pipe 441, wherein the upper fixing seat 431, the heater 10, the lower fixing seat 432 and the air inlet pipe 441 are coaxially arranged, further, the heater is sealed with the upper fixing seat 431 and the lower fixing seat 432, the lower fixing seat 432 is sealed with the air inlet pipe 441, and the air inlet pipe 441 is communicated with external air such that air can enter smoothly when a user smokes.

Referring to FIG. 6 to FIG. 7, the above low-temperature heating smoking set 100 further includes a heat insulation tube 5, wherein the heat insulation tube 5 is arranged inside the fixing shell 42 and is sleeved outside the base body 1, the heat insulation tube 5 can absorb most of the heat generated by the tobacco substrate when radiated by the infrared light, thereby avoiding most heat being transferred to the outer shell 41 to cause a hot feeling. Specifically, an infrared light reflective coating is applied inside the heat insulation tube 5, so as to reflect the infrared lights emitted by the far infrared coating 3 on the base body 1 to the inside of the base body 1 to heat the tobacco substrate inside the heating chamber 13, thereby improving the heating efficiency.

Referring to FIG. 6 to FIG. 7, the above low-temperature heating smoking set 100 further includes a control mainboard 6, a button 7 and a battery 8, wherein the fixing shell 42 includes a front shell 421 and a rear shell 422, the front shell 421 is in fixed connection with the rear shell 422, the control mainboard 6 and the battery 8 are both arranged inside the fixing shell 42, the battery 8 is in electrical connection with the mainboard, the infrared heating tube is also in electrical connection with the mainboard, the button 7 is arranged projecting from the outer shell 41, and by pressing the button 7, electricity connection or disconnection can be realized for the far infrared coating 3 on the lateral surface of the base body 1. In the present embodiment, the control mainboard 6 is also connected to a charging interface 61, wherein the charging interface 61 is exposed on the bottom cover 44, a user can recharge or upgrade the low-temperature heating smoking set 100 through the charging interface 61, to guarantee the continuous use of the low-temperature heating smoking set 100.

Further, in the present embodiment, the low-temperature heating smoking set 100 further includes a temperature measuring element 9, wherein the temperature measuring element 9 is arranged on the base body 1, the temperature measuring element 9 is temperature sensor and is configured for detecting a real-time temperature of the base body 1 and transmitting the detected real-time temperature to the control mainboard 6, and then the control mainboard 6 adjusts the magnitude of the current flowing through the far infrared coating 3 according to the real-time temperature. Specifically, when the temperature measuring element 9 detects the real-time temperature inside the base body 1 is low, for example, when the temperature measuring element 9 detects the real-time temperature inside the base body 1 is lower than 150° C., the control mainboard 6 controls the battery 8 to output a higher voltage to the conductive module 2, thereby increasing the current fed into the far infrared coating 3, increasing the heating power of the tobacco substrate and reducing the time the user needs to wait after a first inhalation. When the temperature measuring element 9 detects the real-time temperature inside the base body 1 is 150° C.-200° C., the control mainboard 6 controls the battery 8 to output a normal voltage to the conductive module 2. When the temperature measuring element 9 detects the real-time temperature inside the base body 1 is 200° C.-250° C., the control mainboard 6 controls the battery 8 to output a lower voltage to the conductive module 2. When the temperature measuring element 9 detects the real-time temperature inside the base body 1 is over 250° C., the control mainboard 6 controls the battery 8 to stop outputting a voltage to the conductive module 2.

Finally, it should be noted that the above embodiments are merely to illustrate, but to limit, the technical scheme of the present disclosure. Under the thought of the present disclosure, technical features in the above embodiments or different embodiments may be combined, steps may be implemented in any order, and there exist many other changes of different aspects for what described above; for conciseness, they are not provided in detail. Although the present disclosure is described in detail with reference to the above embodiments, the ordinary skill in the art should understand that modifications are still possible for the technical schemes described in each above embodiment or partial technical schemes can be equivalently substituted; however, these modifications or substitutions do not get the essence of the technical scheme departed from the scope of the corresponding technical scheme in each embodiment of the present disclosure.

1. A heater, comprising:
a base body, which comprises a first end and a second end opposite to one another, wherein the base body extends along an axial direction between the first end and the second end and is hollow inside to form a heating chamber configured for containing a tobacco substrate;
a conductive module, which at least comprises a first conductive portion and a second conductive portion that are arranged on the base body;
a far infrared coating, which is attached onto the base body between the first conductive portion and the second conductive portion, wherein the first conductive portion and the second conductive portion are both in electrical connection with the far infrared coating; wherein
the first conductive portion comprises a first main part and a first extending section extending from the first main part along the axial direction of the base body, the second conductive portion comprises a second main part and a second extending section extending from the second main part along the axial direction of the base body, the far infrared coating extends from the first main part to the second main part, wherein N is the proportion of a width along the circumferential direction of the base body of the far infrared coating located between the first extending section and the second extending section to a width along the axial direction of the far infrared coating located between the first extending section and the second main part, and/or the proportion of a width along the circumferential direction of the base body of the far infrared coating located between the first extending section and the second extending section to a width along the axial direction of the far infrared coating located between the second extending section and the first main part, and 0.8≤N≤0.2.

2. The heater according to claim 1, wherein the width along the circumferential direction of the base body of the far infrared coating located between the first extending section and the second extending section is equal to the width along the axial direction of the far infrared coating located between the first extending section and the second main part, and/or the width along the circumferential direction of the base body of the far infrared coating located between the first extending section and the second extending section is equal to the width along the axial direction of the far infrared coating located between the second extending section and the first main part.

3. The heater according to claim 1, wherein the base body has a circular section, the far infrared coating is attached on a lateral surface of the base body, the first extending section and the second extending section extend in parallel and are symmetrically arranged on the lateral surface of the base body along a central axis of the base body.

4. The heater according to claim 1, wherein the far infrared coating extending from the first main part to the second main part is uniform in thickness.

5. The heater according to claim 1, wherein the first conductive portion further comprises a third extending section extending from the first main part along the axial direction of the base body; the second conductive portion further comprises a fourth extending section extending from the second main part along the axial direction of the base body; the first extending section, the second extending section, the third extending section and the fourth extending section are arranged on the base body at equal intervals along the circumference direction of the base body; a length of the third extending section along the axial direction of the base body is equal to a length of the first extending section along the axial direction of the base body, and a length of the fourth extending section along the axial direction of the base body is equal to a length of the second extending section along the axial direction of the base body.

6. The heater according to claim 5, wherein N1 is the proportion of a width along the circumferential direction of the base body of the far infrared coating located between the third extending section and the fourth extending section to a width along the axial direction of the far infrared coating located between the third extending section and the second main part, and/or the proportion of a width along the circumferential direction of the base body of the far infrared coating located between the third extending section and the fourth extending section to a width along the axial direction of the far infrared coating located between the fourth extending section and the first main part, and 0.8≤N1≤1.2.

7. The heater according to claim 6, wherein the width along the circumferential direction of the base body of the far infrared coating located between the third extending section and the fourth extending section is equal to the width along the axial direction of the far infrared coating located between the third extending section and the second main part, and/or the width along the circumferential direction of the base body of the far infrared coating located between the third extending section and the fourth extending section is equal to the width along the axial direction of the far infrared coating located between the fourth extending section and the first main part.

8. The heater according to claim 1, wherein the conductive module further comprises a third conductive portion, the third conductive portion is arranged on the base body between the first conductive portion and the second conductive portion, the third conductive portion is in electrical connection with the far infrared coating, and the third conductive portion separates the far infrared coating into two heating areas along the axial direction of the base body, so as to heat the tobacco substrate inside the heating chamber in sections.

9. The heater according to claim 8, wherein the third conductive portion comprises a third main part, a fifth extending section and a sixth extending section that extend along the axial direction of the base body, wherein the fifth extending section extends from the third main part towards the first main part, the sixth extending section extends from the third main part towards the second main part, the fifth extending section and the sixth extending section are arranged on the side surface of the base body at intervals centro-symmetrically to the first extending section and the second extending section respectively.

10. The heater according to claim 9, wherein N2 is the proportion of a width along the circumferential direction of the base body of the far infrared coating located between the fifth extending section and the first extending section to a width along the axial direction of the far infrared coating located between the first extending section and the third main part, and/or the proportion of a width along the circumferential direction of the base body of the far infrared coating located between the fifth extending section and the first extending section to a width along the axial direction of the far infrared coating located between the fifth extending section and the first main part, and 0.8≤N2≤1.2.

11. The heater according to claim 9, wherein N3 is the proportion of a width along the circumferential direction of the base body of the far infrared coating located between the sixth extending section and the second extending section to a width along the axial direction of the far infrared coating located between the sixth extending section and the second main part, and/or the proportion of a width along the circumferential direction of the base body of the far infrared coating located between the sixth extending section and the second extending section to a width along the axial direction of the far infrared coating located between the second extending section and the third main part, and 0.8≤N3≤1.2.

12. The heater according to claim 1, wherein the first conductive portion and the second conductive portion are both a conductive coating applied on the side surface of the base body.

13. The heater according to claim 1, wherein the first conductive portion and the second conductive portion are both a conductive ring sleeved on the side surface of the base body.

14. The heater according to claim 1, wherein the base body is made of quartz glass or mica.

15. A low-temperature heating smoking set, comprising a shell assembly and a heater, wherein the heater is arranged inside the shell assembly,
the heater comprising:
a base body, which comprises a first end and a second end opposite to one another, wherein the base body extends along an axial direction between the first end and the second end and is hollow inside to form a heating chamber configured for containing a tobacco substrate;
a conductive module, which at least comprises a first conductive portion and a second conductive portion that are arranged on the base body;
a far infrared coating, which is attached onto the base body between the first conductive portion and the second conductive portion, wherein the first conductive portion and the second conductive portion are both in electrical connection with the far infrared coating; wherein
the first conductive portion comprises a first main part and a first extending section extending from the first main part along the axial direction of the base body, the second conductive portion comprises a second main part and a second extending section extending from the second main part along the axial direction of the base body, the far infrared coating extends from the first main part to the second main part, wherein N is the proportion of a width along the circumferential direction of the base body of the far infrared coating located between the first extending section and the second extending section to a width along the axial direction of the far infrared coating located between the first extending section and the second main part, and/or the proportion of a width along the circumferential direction of the base body of the far infrared coating located between the first extending section and the second extending section to a width along the axial direction of the far infrared coating located between the second extending section and the first main part, and 0.8≤N≤1.2.

16. The low-temperature heating smoking set according to claim 15, wherein the width along the circumferential direction of the base body of the far infrared coating located between the first extending section and the second extending section is equal to the width along the axial direction of the far infrared coating located between the first extending section and the second main part, and/or the width along the circumferential direction of the base body of the far infrared coating located between the first extending section and the second extending section is equal to the width along the axial direction of the far infrared coating located between the second extending section and the first main part.

17. The low-temperature heating smoking set according to claim 15, wherein the base body has a circular section, the far infrared coating is attached on a lateral surface of the base body, the first extending section and the second extending section extend in parallel and are symmetrically arranged on the lateral surface of the base body along a central axis of the base body.

18. The low-temperature heating smoking set according to claim 15, wherein the far infrared coating extending from the first main part to the second main part is uniform in thickness.

19. The low-temperature heating smoking set according to claim 15, wherein the first conductive portion further comprises a third extending section extending from the first main part along the axial direction of the base body; the second conductive portion further comprises a fourth extending section extending from the second main part along the axial direction of the base body; the first extending section, the second extending section, the third extending section and the fourth extending section are arranged on the base body at equal intervals along the circumference direction of the base body; a length of the third extending section along the axial direction of the base body is equal to a length of the first extending section along the axial direction of the base body, and a length of the fourth extending section along the axial direction of the base body is equal to a length of the second extending section along the axial direction of the base body.

20. The low-temperature heating smoking set according to claim 15, wherein N1 is the proportion of a width along the circumferential direction of the base body of the far infrared coating located between the third extending section and the fourth extending section to a width along the axial direction of the far infrared coating located between the third extending section and the second main part, and/or the proportion of a width along the circumferential direction of the base body of the far infrared coating located between the third extending section and the fourth extending section to a width along the axial direction of the far infrared coating located between the fourth extending section and the first main part, and 0.8≤N1≤1.2.
